(19) United States
(12) Patent Application Publication
(10) Pub. No.: US 2007/0155562 A1
(43) Pub. Date: Jul. 5, 2007

(54) Antifriction bearing mounting

(75) Inventor: Arno Stubenrauch, Aidhausen (DE)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 11/594,926

(22) Filed: Nov. 9, 2006

(30) Foreign Application Priority Data
Nov. 10, 2005 (DE) 10 2005 053 992.0

(51) Int. Cl. F16H 55/30

(52) U.S. Cl. 474/152

(57) ABSTRACT

In a mounting of a pulley on antifriction bearings for driving an accessory assembly, the pulley is designed to be driven by a belt or a chain and the mounting on antifriction bearings is made as a double-row tapered roller bearing which for the two rows of tapered rollers has a common outer ring or inner ring which forms the rolling surfaces for the tapered rollers.

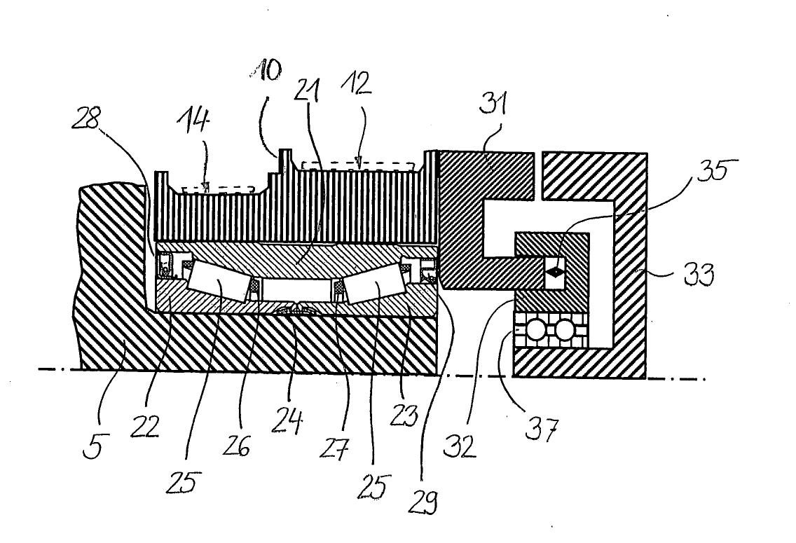

### FIELD OF THE INVENTION

This invention generally pertains to a pulley mount. More specifically, the invention relates to the mounting of a pulley on antifriction bearings for driving an accessory assembly in a motor vehicle.

### BACKGROUND DISCUSSION

In the mounting of belt-driven or chain-driven pulleys, it is generally known to use one or two ball bearings. Disclosed herein is a new mounting for such pulleys.

### SUMMARY

According to one aspect, a mounting of a pulley on an antifriction bearing for driving an accessory assembly in a motor vehicle comprises a pulley adapted to be driven by a belt or a chain, with the pulley being mounted on an antifriction bearing formed as a double-row tapered roller bearing comprising two rows of tapered rollers. The roller bearing possesses a common outer ring or inner ring which forms rolling surfaces for the tapered rollers.

The improved mounting of the pulley on antifriction bearings for driving an accessory assembly in a motor vehicle includes the pulley being designed to be driven by a belt or a chain such that comparatively complex and/or power-intensive load situations can be managed with the mounting on antifriction bearings with relative ease of installation.

It has been discovered that by using a double-row tapered roller bearing at comparable unit volume compared to ball bearings, much higher loads can be accommodated and also partially varying forces which act partially in the axial direction can be better managed. The latter is especially advantageous in a pulley which is made with at least two running surfaces for two belts and/or chains which are separate from one another, the belts or chains acting on the pulley such that a tension load is applied to the pulley in different directions.

Due to its higher load bearing capacity, the tapered roller bearing advantageously accommodates the general development which is underway in automotive engineering toward high performance without this taking place at the cost of compactness. This compactness aspect is furthermore taken into account in that the tapered roller bearing is made with a common outer ring or inner ring which forms the rolling surfaces for the two rows of tapered rollers. The term “common” as used to describe the inner or outer ring means that the common ring is divided at most once between the tapered roller rows, and the two partial rings formed by the division directly adjoin one another, or the indicated ring is made from one piece. In any case, for a common outer or inner ring, the interposition of an intermediate element between the two partial rings for the two rows of tapered rollers is abandoned (is not necessary and is not included). This not only benefits compactness, but also allows relatively great ease of mounting of especially a tapered roller bearing unit which can be mounted as a unit.

According to another aspect, the mounting of a pulley for driving an accessory assembly comprises a pulley mounted on a rotationally fixed bearing journal with a double-row tapered roller bearing positioned between the pulley and the bearing journal. The pulley possesses a first track for receiving a drive member for driving the pulley and a second track for receiving a transmission member to transmit rotary motion of the pulley. The double-row tapered roller bearing comprises an inner ring, an outer ring and two rows of tapered rollers positioned between the inner and outer rings, at least one of the inner and outer rings being a one-piece ring possessing rolling surfaces for the two rows of tapered rollers.

### BRIEF DESCRIPTION OF THE DRAWING FIGURE

Other features and details of the mounting disclosed herein will become more apparent from the following detailed description considered with reference to the accompanying drawing FIGURE which is a lengthwise cross-sectional view of a pulley mounting.

### DETAILED DESCRIPTION

The accompanying drawing FIGURE is a lengthwise cross-sectional view through the top half of the mounting of a pulley 10 on antifriction bearings as one embodiment disclosed herein. In the illustrated embodiment, the pulley 10 comprises a first track 12 for receiving or locating an elongated driving member (schematically shown with dashed lines in the drawing FIGURE) in the form of, for example, a first belt for driving the pulley 10. The pulley also comprises a second track 14 for receiving or locating an elongated transmission member (schematically shown with dashed lines in the drawing FIGURE) in the form of, for example, a second belt for continued transmission of the rotary motion to another unit.

For pivotable mounting of the pulley 10, a double-row tapered roller bearing is provided between the pulley 10 and a bearing journal 5 which is not designed to rotate. The tapered roller bearing comprises an outer ring member and an inner ring member. In the illustrated embodiment, the outer ring member is an outer ring 21 which is common to the two rows of tapered bearings, and forms the two rolling surfaces for the two rows of tapered rollers, and which is permanently connected to the pulley 10. The illustrated embodiment also shows the inner ring member being formed as two inner rings 22, 23. Each of the inner rings 22, 23 forms a rolling surface for one of the rows of tapered rollers. The two inner rings 22, 23 in the axial direction are designed to directly adjoin one another, are connected to one another via a clip ring 24, and are located securely on the bearing journal 5. In the illustrated embodiment, the common outer ring 21 is a one-piece ring and the tapered roller bearing is made in an O arrangement.

In addition, two seals 28, 29 are located at respective axial end regions of the tapered roller bearing between the respective inner ring 22, 23 and the outer ring 21 for sealing the space which contains the tapered rollers 25 and in which lubricating grease is additionally placed. The tapered rollers 25 of each of the two rows of tapered rollers are each guided in a respective cage 26, 27. In this regard, the tapered roller bearing is especially well suited to accommodate the forces applied by the two belts in different directions to the pulley 10 and to divert them to the bearing journal, thus resulting in a longer service life of the mounting.

In a variation on the illustrated embodiment, the outer ring member can be made in two parts in a manner similar to the illustrated inner ring member, or the inner ring member can be made as a one-piece common ring and for this purpose the outer ring can be made in two parts.

A first part 31 of a clutch arrangement is securely connected to the pulley 10, and a second part 32 of the clutch arrangement can be moved axially against the first part in the conventional manner. A third part 33 of the clutch arrangement is connected to the second part 32 especially via another antifriction bearing mounting 37. The third part 33 has a section which positively and/or non-positively adjoins one region of the first part 31 by axially moving the second part 32 and thus also the third part 33 relative to the first part 31 in the coupled state, or as shown does not adjoin it in the decoupled state. Thus, the third part 33 is either connected in a torsionally strong manner to the first part 31 or is rotationally decoupled from the first part 31. In this regard, the first part 31 and the second part 32 are connected in a known manner to means 35 for effecting the axial movement of the indicated parts 31, 32 which is directed against one another.

For example, a fan which is used within the framework of the cooling circuit of an internal combustion engine of a motor vehicle is strongly torsionally connected to the third part 33, with the internal combustion engine as the main drive driving the accessory assembly via the above described pulley arrangement.

In other embodiments, instead of two tracks for two driving members (e.g., belts), there can also be only one track, with the pulley being made in at least two parts, especially separating the two tracks for the two belts from one another, therefore especially two pulleys and/or the two tracks can be driven so-to-speak in parallel.

In the case of driving and transmission members in the form of belts, the belts can be made as V-belts or toothed belts along with a corresponding formation of the tracks suitable to cooperate with such belts, and/or chains can also be used instead of belts, with the pulley then being configured similar to a gear wheel.

In other variations, accessory assemblies other than fans, for example a generator or a starter-alternator, can be connected to the pulley and/or the presence of a clutch between the pulley and the actual auxiliary assembly can be abandoned. Also, the above described arrangement(s) can also be used outside of automotive engineering applications.

The principles, preferred embodiment(s) and modes of operation have been described in the foregoing specification. However, the invention which is intended to be protected is not to be construed as limited to the particular embodiment(s) disclosed. Further, the embodiment(s) described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. Mounting of a pulley for driving an accessory assembly comprising a pulley mounted on a rotationally fixed bearing journal with a double-row tapered roller bearing positioned between the pulley and the bearing journal, the pulley possessing a first track for receiving a drive member for driving the pulley and a second track for receiving a transmission member to transmit rotary motion of the pulley, the double-row tapered roller bearing comprising an inner ring member, an outer ring member and two rows of tapered rollers positioned between the inner and outer ring members, the inner and outer ring members each possessing rolling surfaces for the two rows of tapered rollers.

2. Mounting according to claim 1, wherein the outer ring member is a one-piece outer ring and the inner ring member comprises two inner rings adjoining one another.

3. Mounting according to claim 1, wherein the tapered roller bearing includes grease lubrication.

4. Mounting according to claim 1, comprising sealing means located at both axial end region of the tapered roller bearing for sealing a space containing the tapered rollers.

5. Mounting according to claim 4, wherein the sealing means is located between the outer ring member and the inner ring member.

6. Mounting according to claim 1, wherein the accessory assembly is a fan.

7. Mounting according to claim 1, wherein the first and second tracks are two tracks which are separate from one another.

8. Mounting according to claim 1, wherein the drive member and the transmission member are adapted to be connected to the pulley such that they apply a tension load to the pulley in directions which differ from one another.

9. Mounting according to claim 1, wherein the pulley is made with a capacity to be coupled to the accessory assembly.

10. Mounting of a pulley on an antifriction bearing for driving an accessory assembly in a motor vehicle, the mounting comprising a pulley adapted to be driven by a belt or a chain, the pulley being mounted on an antifriction bearing formed as a double-row tapered roller bearing comprising two rows of tapered rollers, the roller bearing possessing a common outer ring or inner ring which forms rolling surfaces for the tapered rollers.

11. Mounting according to claim 10, wherein the tapered roller bearing is made in an O arrangement.

12. Mounting according to claim 10, wherein the common outer or inner ring is made in one piece.

13. Mounting according to claim 10, wherein the common outer or inner ring is divided transversely to an axial direction of the bearing at most once between the rolling surfaces for the two rows of tapered rollers forming two partial rings directly adjoining one another.

14. Mounting according to claim 10, wherein the tapered roller bearing is designed for grease lubrication.

15. Mounting according to claim 10, comprising sealing means located in at least one axial end region of the tapered roller bearing for sealing a space containing the tapered rollers.

16. Mounting according to claim 10, wherein the sealing means is located between the inner ring and the outer ring.

17. Mounting according to claim 10, wherein the accessory assembly is a fan.

18. Mounting according to claim 10, wherein the pulley comprises two tracks separate from one another each for receiving one of the belt and the chain.

19. Mounting according to claim 10, wherein the belts and/or chains are adapted to be connected to the pulley to apply tension loads to the pulley in directions which differ from one another.

20. Mounting according to claim 10, wherein the pulley is made with the capacity to be coupled to the accessory assembly.
